(19) United States
(12) Patent Application Publication
(10) Pub. No.: US 2010/0097810 A1
(43) Pub. Date: Apr. 22, 2010

(54) ULTRA HIGH EFFICIENT ENCAPSULATION STRUCTURE HAVING METAL HEAT SINK

(76) Inventor: Chia-Mao Li, Taipei (TW)

Correspondence Address: Chia-Mao Li, 235 Chung - Ho Box 8-24, Taipei, TW

(21) Appl. No.: 12/253,237

(22) Filed: Oct. 16, 2008

(51) Int. Cl. F21V 7/20

(52) U.S. Cl. 362/345

(57) ABSTRACT

An ultra high efficient encapsulation structure includes a reflection cup, a metal heat sink, and a heat conducting base. The heat conducting base has a slot for being inserted by the metal heat sink. The metal heat sink is formed as guiding planes which are suitable for a flat lighting characteristic of a LED so as to change the angle of lights and raise the optical efficiency. The metal heat sink is a good heat conductor with high thermal capacity so that heat on a LED chip is absorbed quickly and being conducted to the heat conducting base through a larger surface thereof. Heat on the LED chips of the metal heat sink is dissipated quickly so that temperatures of the LED chips are substantially lowered. The reflection cup suitable for the flat lighting characteristic of the LED is fixed to an outer edge of the metal heat sink.

### FIELD OF THE PRESENT INVENTION

The present invention relates to encapsulation, and particular to an ultra high efficient encapsulation structure having a metal heat sink being arranged by guiding planes which are suitable for a flat lighting characteristic of a LED so as to change the angle of light and raise the optical efficiency. The metal heat sink is a good heat conductor with high thermal capacity so that heat on LED chips is absorbed quickly and being conducted to a heat conducting base through a large surface thereof. Heat on the LED chips of the metal heat sink is dissipated quickly so that temperatures of the LED chips are substantially lowered;

### DESCRIPTION OF THE PRIOR ART

Light emitting diode (LED) has advantages of power saving, small size, capability of emitting light in different colors, and environment-friendly. It is well applied on cell phones, automobiles, back light for medium and small size panels, traffic lights, and further into illumination field. Recently, LED illumination for outdoors is extensively developed so as to take the place of traditional illumination. However, high power LED has a thermal problem. The higher the power of the LED is, more heat is generated, and the LED keeps higher temperature. While the temperature of a LED chip goes higher, the light output efficiency is lowered and the life time of the LED chip is shortened. Thus, a good lamp body structure with well heat dissipation ability, suitable for a flat lighting characteristic of a LED, capable of changing angle of light, raising optical efficiency is an important subject to develop.

On the other hand, the prior illuminating device also keeps improving on heat dissipation such as a Taiwan patent no. M289519 about an ultra high efficiency package structure. According to the patent, a single or multiple LED chips are installed on a carrying surface of a metal heat sink of well thermal conductibility, and the metal heat sink is sat on a heat conducting base through a heat conducting and electrical insulating layer. The three components are combined so as to dissipate heat on the LED chips quickly. However, a LED array arrangement will have the lights been blocked and absorbed by the LED chips so that the lighting efficiency will be lowered. While the quantity of the LED chips or the power of the LED chip is higher, temperature of certain part of LED chips goes too high. Accordingly, a good and simple structure to solve the thermal problem is provided in the following. With guiding planes added to the metal heat sink, a structure of the guiding planes enlarges the heat dissipation area so that heat on the LED chips are dissipated and temperature of the metal heat sink will not reach too high. In the same time, the guiding planes can change projecting angle of lights so as to raise optical efficiency. With a surface area added by the metal heat sink, heat on the LED chips of the metal heat sink is absorbed quickly and being conducted to the heat conducting base so that heat on the LED chips of the metal heat sink is dissipated quickly and temperatures of the LED chips are substantially lowered. The comprehensive heat dissipating effect can extend a lifetime of the LED and it is also the technical point that the inventor of the present invention want to solve.

### SUMMARY OF THE PRESENT INVENTION

To achieve above objects, an ultra high efficient encapsulation structure according to the present invention includes a reflection cup, a metal heat sink, and a heat conducting base. The heat conducting base has a slot for being inserted by the metal heat sink. The metal heat sink is formed as guiding planes which are suitable for a flat lighting characteristic of a LED so as to change the angle of lights and raise the optical efficiency. The metal heat sink is a good heat conductor with high thermal capacity so that heat on a LED chip is absorbed quickly and being conducted to the heat conducting base through a larger surface thereof. Heat on the LED chips of the metal heat sink is dissipated quickly so that temperatures of the LED chips are substantially lowered. The reflection cup suitable for the flat lighting characteristic of the LED is fixed to an outer edge of the metal heat sink. The reflection cup has a reflecting curved surface on an inner wall thereof. By the different reflecting curvatures of the reflection cup, different light distributions are projected.

### BRIEF DESCRIPTION OF THE DRAWINGS

FIG. 1 is an exploded view of the present invention.

FIG. 2 is an assembly view of the present invention.

FIG. 3 is a schematic view showing an embodiment of a metal heat sink of the present invention.

FIG. 4 is an exploded view of another preferable embodiment of the present invention.

FIG. 5 is a schematic view of an embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

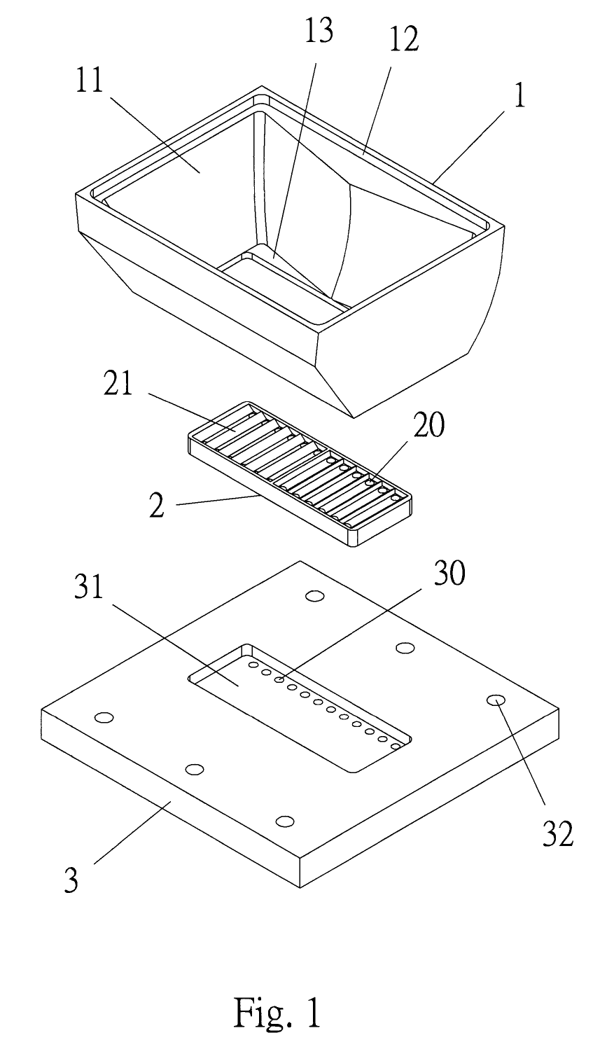

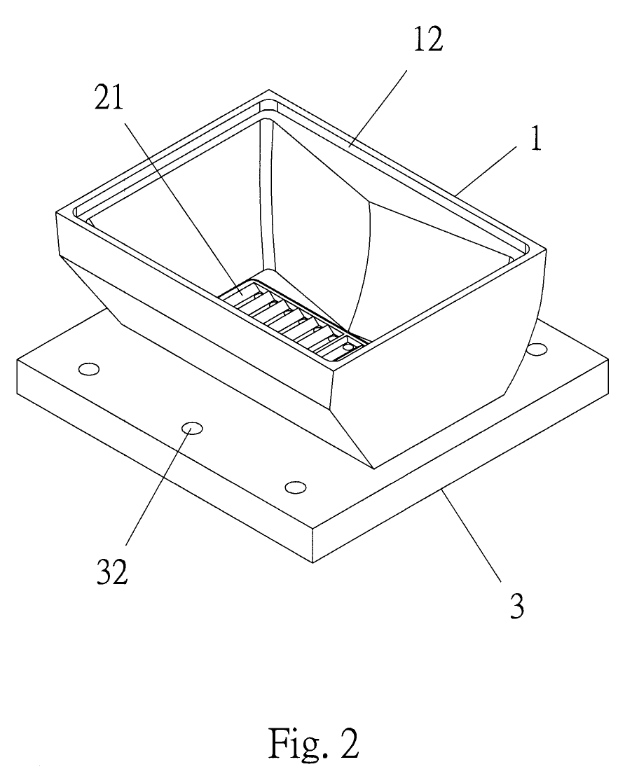

Referring to FIGS. 1 and 2, an ultra high efficient encapsulation structure according to the present invention includes a reflection cup 1, a metal heat sink 2, and a heat conducting base 3. The heat conducting base 3 has a slot 31 and through holes 32. The slot 31 is inserted by the metal heat sink 2 for fixing. The through holes 32 are screwed by bolts to fix to a lighting device. The slot 31 further has through holes 30 formed inside thereof. The metal heat sink 2 is formed as guiding planes 21 which are suitable for a flat lighting characteristic of a LED so as to change the angle of light and raise the optical efficiency. The metal heat sink 2 is a well heat conductor and with high thermal capacity so that heat on LED chips is absorbed quickly and being conducted to the heat conducting base 3 through a large surface thereof. Heat on the LED chips of the metal heat sink 2 is dissipated quickly so that temperatures of the LED chips are substantially lowered. The reflection cup 1 suitable for the flat lighting characteristic of LED is fixed to an outer edge of the metal heat sink 2. The reflection cup 1 is a hollow body with two openings and a reflecting curved surface 11 is formed on an inner wall. A concave edge 12 is formed to an opening of the reflection cup 1 and a joint 13 connected to the outer edge of the metal heat sink 2 is formed to another opening of the reflection cup 1. By the different reflecting curvatures of the reflection cup 1, different light distributions are projected.

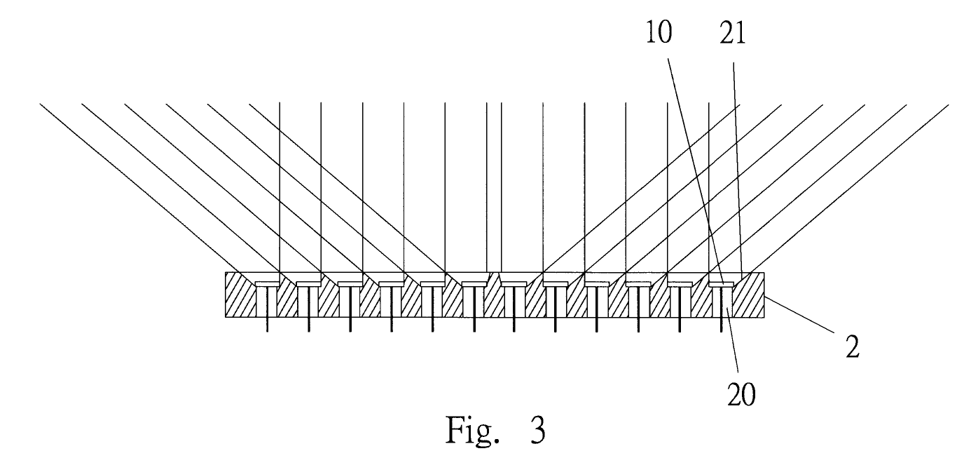

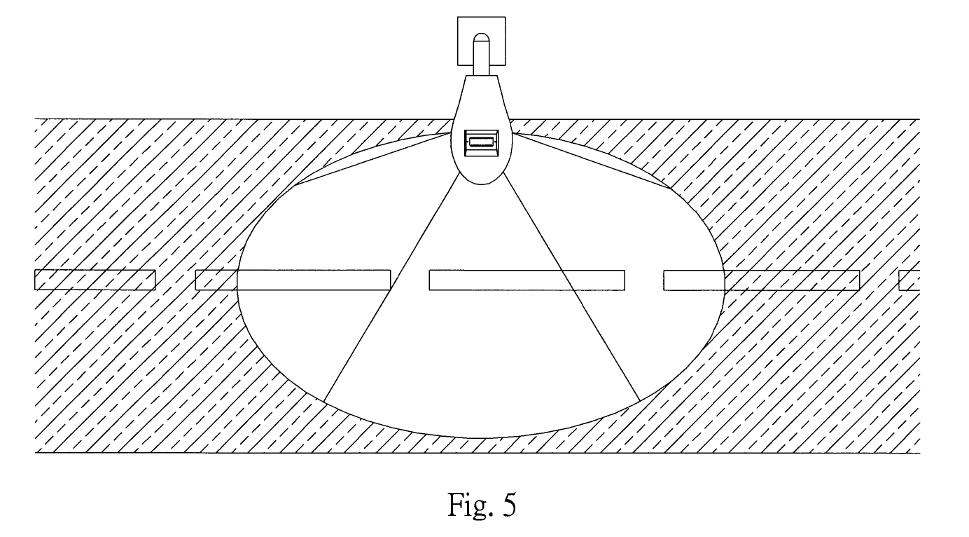

With reference to FIGS. 3 and 5, through holes 20 are formed to the metal heat sink 2 for arranging the pins of the LED chips 10. The guiding planes 21 are formed on a surface of the metal heat sink 2 by stamping beside the through holes 20. Guiding planes 21 having large inclined planes on a right side of the through holes 20 are formed on the right half surface of the metal heat sink 2, while guiding planes 21 with inclined plane on a left side of the through holes 20 are formed on a left surface of the metal heat sink 2. Lights emitted from the LED chips 10 will be guided to the right and left by the guiding planes 21 and through the reflecting curved surface 11 of the reflection cup 1, lights will be projected uniformly on both right and left sides.

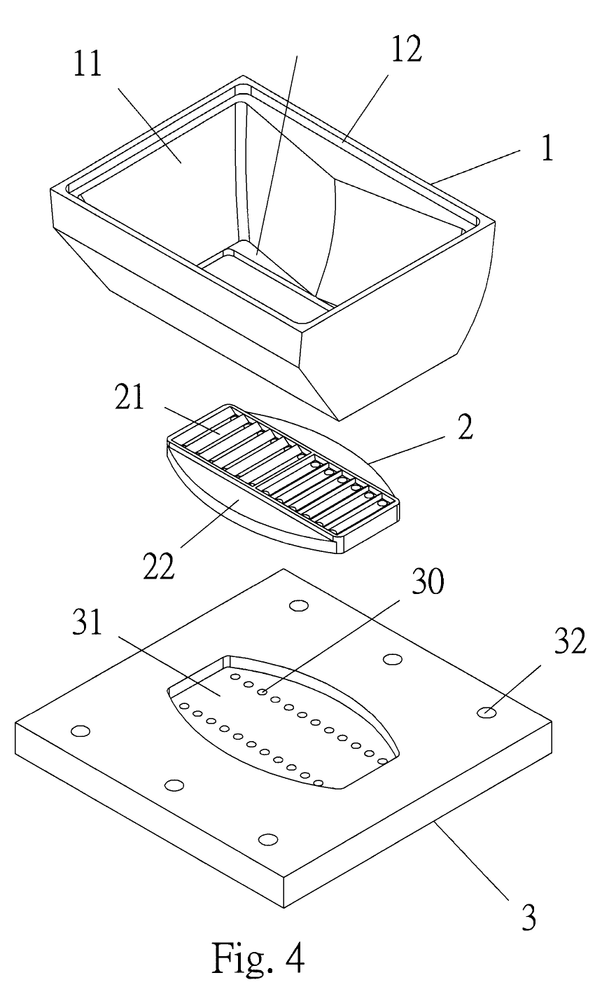

Referring to FIG. 4, another preferable embodiment of the present invention is illustrated. To have a higher efficiency of heat dissipation, a heat dissipating area of the metal heat sink 2 is enlarged. Wing sheets 22 are added for enlarging the contact area between the metal heat sink 2 and the heat conducting base 3 so that heat on high power LED chips are absorbed and being conducted to the heat conducting base 3 more quickly. Heat on the LED chips of the metal heat sink 2 is dissipated quickly so that temperatures of the LED chips are substantially lowered.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An ultra high efficient encapsulation structure comprising:
a reflection cup suitable for a LED flat lighting and having a light reflecting curved surface inside thereof;
a metal heat sink being arranged by the reflection cup on an outer edge thereof; the metal heat sink being arranged by guiding planes which are suitable for the flat lighting characteristic of the LED so as to change the angle of lights and raise the optical efficiency; the metal heat sink being a good heat conductor with high thermal capacity so that heat on LED chips is absorbed quickly and being conducted to a heat conducting base through the large surface thereof; heat on the LED chips of the metal heat sink being dissipated quickly so that temperatures of the LED chips are substantially lowered; and
the heat conducting base having a slot for being inserted by the metal heat sink.

2. The ultra high efficient encapsulation structure as claimed in claim 1, wherein the heat conducting base has through holes for being screwed by bolts to be fixed to a lighting device.

3. The ultra high efficient encapsulation structure as claimed in claim 1, wherein through holes are formed on the metal heat sink for arranging the pins of the LED chips.

4. The ultra high efficient encapsulation structure as claimed in claim 1, wherein guiding planes are formed on a surface of the metal heat sink beside the through holes; guiding planes having large inclined planes on a right side of the through holes are formed on a right half surface of the metal heat sink, while guiding planes with large inclined planes on a left side of the through holes are formed on a left surface of the metal heat sink.

5. The ultra high efficient encapsulation structure as claimed in claim 1, wherein the metal heat sink further has wing sheets.
